(19) United States
(12) Patent Application Publication
(10) Pub. No.: US 2026/0346530 A1
(43) Pub. Date: Nov. 5, 2026

(54) DEVICE AND METHOD FOR CHECKING THE SETTING OF AN EXTRUSION DEVICE

(71) Applicant: SIKORA GmbH, Bremen (DE)

(72) Inventors: Kolja Tobias Schuh, Bremen (DE); Harald Sikora, Bremen (DE)

(73) Assignee: SIKORA GmbH, Bremen (DE)

(21) Appl. No.: 19/487,532

(22) PCT Filed: Apr. 15, 2024
(86) PCT No.: PCT/EP2024/060166

§ 371 Date: Nov. 25, 2025

(30) Foreign Application Priority Data
Jun. 8, 2023 (EP) 23178231.9

(51) Int. Cl. B29C 48/92; B29C 48/09; B29L 23/00

(52) U.S. Cl. CPC B29C 48/92; B29C 48/09; B29C 2948/92152; B29C 2948/92428; B29C 2948/9258; B29C 2948/92704; B29L 2023/22

(57) ABSTRACT

A device for checking the setting of an extrusion device includes a first measuring apparatus to measure the wall thickness of at least one wall of a tubular object at a first position. A second measuring apparatus measures the wall thickness of the at least one wall of the tubular object at a second position that is downstream of the first position. An evaluation apparatus receives the wall thickness values from the measuring apparatuses. The measured wall thickness values from the first measuring apparatus experience a delay time that corresponds to the conveying time of the tubular object between the first and second positions. The evaluation apparatus checks a ratio of the outlet widths of the extruded material set at the extrusion device at a top and a bottom of the extruder nozzle based on a comparison of the measured wall thickness values from the first and second measuring apparatuses.

### CROSS REFERENCE TO RELATED APPLICATIONS

This application is a national stage application pursuant to 35 U.S.C. § 371 of International Application No. PCT/EP2024/060166, filed on Apr. 15, 2024, which claims priority to, and benefit of, European Patent Application No. 23178231.9, filed Jun. 8, 2023, the entire contents of which are hereby incorporated by reference.

### TECHNOLOGICAL FIELD

The present disclosure is directed to a device and a method for checking the setting of an extrusion device producing a tubular object conveyed in a conveying direction.

### BACKGROUND

Plastic tubes for supplying gas and water to residential and industrial areas, but also for drainage, are mainly made from materials such as HDPE, PP and PVC. Typical tube diameters are up to 3 m, with wall thicknesses of up to 250 mm. Production usually takes place in extrusion devices in which a plastic raw material is melted and discharged through a usually annular extruder nozzle. The tube extruded in this way is drawn off the extrusion device in the longitudinal direction and thus conveyed. The diameter of the hauled-off tube is formed to the desired outer diameter in a downstream, for example sleeve-shaped, calibration device. In the course of conveying, the tube usually passes through several cooling sections in which the tube is cooled and thus the plastic melt, which is initially still flowable, gradually solidifies. In a first cooling section, the formed tube is prevented from collapsing, for example, by a vacuum. The tube is often cooled in the cooling sections by a coolant such as water. The cooling water flows around the tube and quickly solidifies its outer region. After exiting the first cooling section, the outer surface of the tube is therefore usually hardened, so that the outer geometry of the tube subsequently changes only slightly. Inside the tube wall, however, there are usually still flowable components of the tube material after it exits the first cooling section. As the tubular object continues to be conveyed, the inside of the tube up to the inner surface of the tube also gradually cools and hardens, in particular as it passes through further cooling sections. The tube is then cut to the desired length using a flying saw.

The shaping of the tube in the course of complete hardening after it exits the extrusion device is essentially influenced by two effects that must be taken into account in order to achieve a wall thickness of the tube that is, for example, as uniform as possible. On the one hand, this is a shrinkage of the tube material that occurs during cooling. On the other hand, this is sagging, i.e. the viscous mass components that are still capable of flowing sink during hardening due to the influence of gravity.

In response to these effects, which influence the final geometry of the tubular object, it is known to set a larger outlet width for extruded material in an upper region of the extruder nozzle of the extrusion device than in a lower region. To set the outlet widths, an outlet gap of the extruder nozzle can be set wider in the upper region than in a lower region. Alternatively, or additionally, the extruder nozzle can be heated more in an upper region than in a lower region, thereby achieving a larger outlet width of the extruded material in the upper region than in the lower region of the extruder nozzle. Both measures therefore ensure that more material exits in the upper region of the extruder nozzle than in the lower region. This deliberately asymmetrical discharge of the material is intended to compensate for sagging so that the hardened tube has a wall thickness that is as uniform as possible over its entire circumference.

Important geometric values of the tube, such as wall thickness and diameter, can only be finally measured after the tube has completely hardened, i.e. at the end of all cooling sections of the tube, when shrinkage and sagging are completely finished. A typical output rate of an extrusion device for medium tube cross-sections is around 1,000 kg/h. Depending on the material, the temperature of the melt when it exits the extruder nozzle is around 200 °C to 240 °C. For a tube with an outer diameter of 330 mm and a wall thickness of 30 mm, for example, and a typical cooling section for the tube of 60 m, initial measurement results for the wall thickness and diameter are often only available hours after the start of production. Only then can the production parameters of the extrusion device be influenced if geometric deviations from target values are detected, whereby any changes made can in turn only be checked again after several hours. Several corrections that are often necessary to achieve an optimum process after a process start requires several days, for example to set the wall thickness uniformly over the circumference and to its nominal value.

To compensate for the sagging, the outlet width or rather wall thickness of the extruded material is set larger in the upper region than in the lower region when setting the extruder nozzle, as explained. In order not to fall below a minimum wall thickness even if sagging occurs, the sagging is usually overcompensated using empirical values. Ultimately, this leads to an unnecessary amount of material being discharged.

It is therefore desirable to obtain information about the expected shrinkage and expected sagging of a tube produced in an extrusion device as early as possible. Measuring, for example, the wall thickness and the diameter of a tube after the first cooling section cannot correspond to the desired final values that would be found after the tube has completely cooled down, because at this point the wall of the tube only has solidified material in the outer region and still has recrystallizing components and melt in the interior. As a result, diameter and wall thickness values that are still subject to shrinkage and sagging are recorded at a measurement position after a first cooling section. Predicting the expected shrinkage and sagging values as early as possible is of great economic importance in order to speed up the start-up process and continuously ensure the nominal values.

DE 40 18 051 A1 discloses a device closed-loop control of the outer diameter of a strand, in particular a cable, in which a first diameter measuring device is arranged downstream of an extruder and a second diameter measuring device is arranged at a distance from the extruder, preferably downstream of a cooling section for the strand. A diameter measuring signal from the first diameter measuring device is applied to a first comparison device and to a delay stage, the delay time of which corresponds to the time that the strand travels between the first and second diameter measuring devices. A second comparison device compares the diameter measuring signal of the second diameter measuring device with the delayed first diameter measuring signal. The difference signal of the second comparison direction is applied to the first comparison device in addition to a cold target value of the diameter. If a deviation from the cold target value is detected by the first comparison device, the deviation is fed to a controller to control the outer diameter of the strand in a closed-loop manner. The device described in DE 40 18 051 A1 can be used to measure the shrinkage of the strand between the measurement positions of the first and second diameter measuring device, wherein the delay ensures that the actual shrinkage of the strand is measured.

In WO 2022/058081 A1, a method is proposed for determining geometric parameters of a strand-or plate-shaped object, with which the shrinkage is predicted. For this purpose, a relationship between the refractive index of the object and a shrinkage that occurs during its solidification is ascertained in an ascertaining step. In a determining step, the refractive index and at least one geometric parameter of the not yet fully solidified object are determined, in particular after a first cooling section of the object, and a geometric parameter in the fully solidified state of the object is calculated from the determined values, taking into account the relationship ascertained in the ascertaining step. A prediction is therefore made of the shrinkage of the material of the object in the course of its solidification, and on this basis a calculation of a geometric parameter, such as a wall thickness, in the fully solidified state of the object is made.

With the methods explained, the shrinkage can be reliably predicted and taken into account as one of the two effects that exert a decisive influence on the final geometry, wherein the measured values are advantageously available shortly after the material exits the extrusion device and the final geometric parameter can be calculated accordingly at an early stage to avoid rejects. However, the sagging as the second decisive effect for the final geometry of the object cannot be predicted using the known methods, for reasons explained in more detail below.

A method for ascertaining the sagging that has occurred in a tube extruded in an extrusion device is known from WO 2022/106180 A1. The wall thickness of the tube is measured over the circumference of the tube and the measured wall thicknesses are used to create a wall thickness profile over the circumference of the tube. Sagging of the melt is ascertained from the frequency and/or the amplitude of the wall thickness profile. While this method enables reliable detection of the sagging, it is not possible to predict the sagging using this method either.

EP 2 086 744 B1 also discloses a method for operating a production system for manufacturing a strand, in which an extruder model of an extruder is stored in a computer. When production of the strand starts, the extruder model is used to calculate the value for the diameter and/or wall thickness of the strand predictably produced by the extruder depending on the values for the inner diameter, the line speed, the screw speed of the extruder and the speed-dependent data for the output rate of the extruder. The calculated value for diameter and/or wall thickness is displayed and the calculated and displayed value for diameter and/or wall thickness is brought to a target value for diameter and/or wall thickness by changing the screw speed of the extruder and/or the line speed by means of manual actuation or closed-loop control. At a distance from the extruder, at a measurement location where the strand has completely passed through the cooling section for cooling, the diameter and/or the wall thickness of the strand is measured with a measuring head. Due to the extruder model, the actual value for diameter and/or wall thickness measured by the measuring head is already very close to the respective target value. Any remaining deviation can be eliminated by controlling the extruder accordingly. The method described in EP 2 086 744 B1 works as if a (virtual) measuring head, which already displays the cold values for the diameter and/or wall thickness of the strand at this early point in time of production, were arranged between the extruder and the cooling section. Using the method described, the production system can be set at a very early stage, particularly before the strand reaches the measuring head, to values that avoid rejects. However, creating the extruder model involves some effort and must be adapted when changes are made to the components of the production system, which often requires extensive empirical tests to be carried out.

### BRIEF SUMMARY OF THE INVENTION

Starting from the state of the art described above, the invention is based on the object of providing a device and a method of the type mentioned at the outset, with which the setting of the extrusion device can be reliably checked and, if necessary, corrected, in particular taking into account the sagging of a tubular object produced in an extrusion device.

Aspects of the present disclosure are directed to embodiments of a device for checking the setting of an extrusion device including a first wall thickness measuring apparatus configured to measure the wall thickness of at least one wall of the tubular object at a first measurement position arranged in the conveying direction upstream of at least one cooling section for the tubular object. Embodiments of the device further include a second wall thickness measuring apparatus configured to measure the wall thickness of the at least one wall of the tubular object at a second measurement position arranged in the conveying direction downstream of the first measurement position. In some embodiments, the device includes an evaluation apparatus configured to receive measured wall thickness values from the first wall thickness measuring apparatus and measured wall thickness values from the second wall thickness measuring apparatus. The measured wall thickness values from the first wall thickness measuring apparatus are delayed compared to the measured wall thickness values from the second wall thickness measuring apparatus by a delay stage of the device, where the delay time corresponds to the conveying time of the object between the first and second measurement positions. The evaluation apparatus is configured to check the ratio of the outlet widths of the extruded material set at the extrusion device at the top and at the bottom of the extruder nozzle by comparing the measured wall thickness values from the first wall thickness measuring apparatus, which are delayed by the delay stage, with the measured wall thickness values from the second wall thickness measuring apparatus.

Aspects of the present disclosure are also directed to embodiments of a method for checking the setting of an extrusion device using a device according to the invention.

In some embodiments, the setting of an extrusion device producing a tubular object can be checked and, if necessary, corrected, as explained below, in particular also taking into account the sagging still to be expected after the first measurement position, i.e. the sagging of the still flowable, viscous mass components of the tubular object exiting the extrusion device during hardening due to the influence of gravity.

In a manner known per se, the extrusion device has an extruder nozzle, for example in the shape of a circular ring, from which the previously melted plastic material exits. In a manner also known per se, after exiting the extrusion device the tubular object regularly passes through several cooling sections, in which the material of the object is successively cooled, for example by a coolant such as water, until it cools down and thus hardens completely. For example, after exiting the first cooling section immediately downstream of the extrusion device, the outer surface of the tubular object may already have hardened, such that the shaping of the outer surface of the tubular object is completed. Inside the tube wall, on the other hand, the material of the tubular object still has recrystallizing regions and melt components and is accordingly at least partially still flowable, wherein sagging is known to occur in addition to shrinkage as the object cools. For the final shaping of the tubular object in the first cooling section, it is possible for the object material to be pressed against the, for example cylindrical, inner surface of a calibration sleeve by, for example, applying a vacuum.

In principle, it is possible to model in detail not only the shrinkage but also the sagging to be expected using the Navier-Stokes equations based on precisely known framework conditions and material properties of the tubular object. However, this is so numerically complex that it is not practicable for a rapid prediction of the sagging desired here. According to the invention, a reliable prediction of the sagging is still to be expected and thus the final shape of the object should be available as early as possible after it exits the extrusion device in order to avoid rejects, so that it is possible to intervene in the production process at an early stage if necessary, for example by adapting the settings of the extrusion device. The prediction of the sagging should preferably be made in real time. Both of these factors prevent the use of the Navier-Stokes equations, which are in themselves reliable, in this application.

Unlike shrinkage, sagging cannot be predicted in the manner explained in WO 2022/058081 A1, as already mentioned. The shrinkage from the extrusion temperature to complete cooling is independent of the temporal progression of the hardening, in particular the cooling sped. It is also not possible to significantly influence the shrinkage by changing parameters of, for example, the extrusion device or the cooling parameters. This is essentially an unchangeable process characteristic, but one that can be predicted relatively easily.

The situation is different with sagging, where the processes are far more complex than with shrinkage. With sagging, first the temperature-dependent flow behavior of the material, its temperature and the speed of cooling play a significant role. In general, it can be stated that the higher the initial temperature of the melt and the more time it takes for the melt to cool and harden completely, the more pronounced the sagging of the melt during the production of tubes will be. Varying operating conditions with regard to the extrusion temperature, the extruder feed rate, the haul-off speed and the intensity and duration of the cooling influence the degree of sagging. While to predict shrinkage using, for example, the refractive index, a system stop in which the change in the refractive index is recorded together with the shrinking wall thickness and the diameter over several hours of cooling is sufficient, this reliable method cannot be used to predict the sagging, precisely because the sagging of the wall thickness will be significantly more or less pronounced if cooling takes place over a longer or shorter period of time. Sagging-unlike shrinkage-can also be decisively influenced by changing the parameters of the extrusion device and the cooling parameters for the tubular object.

In some embodiments, the tubular object produced in the extrusion device is conveyed along its longitudinal axis in a conveying direction during the measurement. In some embodiments, the tubular object is in particular a tube, for example a plastic tube. It may be a multi-layer tube. In some embodiments, the tubular object can also be a cable, in which the hollow space formed by the tubular shape and running in the longitudinal direction is filled by one or more electrical conductors. According to some embodiments of the invention, a first wall thickness measuring apparatus is used to measure at least one wall of the tubular object at a first measurement position arranged in the conveying direction upstream of at least one cooling section for the tubular object. As is known, objects produced in extrusion devices pass through one or more cooling sections, in which the object is successively cooled, for example by spraying on a coolant. At the first measurement position, the tubular object exiting the extrusion device at a high temperature still has an elevated temperature, such that the object still in particular has flowable components, that is to say melt components.

According to some embodiments of the invention, a second wall thickness measuring apparatus is used to measure the wall thickness of the at least one wall of the tubular object at a second measurement position arranged in the conveying direction downstream of the first measurement position. At the second measurement position, which may in particular be arranged downstream of at least one cooling section arranged between the first measurement position and the second measurement position, the temperature of the object has already cooled down so that it has at least fewer still flowable components, preferably has essentially reached its cold state, that is to say its completely hardened state. So, while the first wall thickness measuring apparatus measures a hot value of the wall thickness, which regularly changes as it cools down further, the second wall thickness measuring apparatus can measure the cold value of the wall thickness and thus the final wall thickness of the tubular object.

In some embodiments, the measured wall thickness values from the first wall thickness measuring apparatus are transmitted to an evaluation apparatus via a delay stage, the delay time of which corresponds to the conveying time of the object between the first and second measurement positions. The evaluation apparatus continues to receive measured wall thickness values from the second wall thickness measuring apparatus, without the delay caused by the delay stage. The evaluation apparatus compares the measured wall thickness values from the first wall thickness wall thickness measuring apparatus, which are delayed by the delay stage, with the measured wall thickness values from the second wall thickness measuring apparatus. Thus, the evaluation apparatus compares measured wall thickness values from the first and second wall thickness measuring apparatuses with each other, which were obtained at the same position in the conveying direction of the tubular object due to the relative time shift caused by the delay stage. This means that the measured wall thickness values are compared at the same location, from which the actual change in wall thickness values between the first and second measurement positions can be precisely ascertained. Of course, it is also possible for the measured wall thickness values from the first wall thickness measuring apparatus and the measured wall thickness values from the second wall thickness measuring apparatus to undergo a further delay, which is then identical for both wall thickness measuring apparatuses, so that the measured wall thickness values continue to be compared at the same location.

Based on the comparison carried out by the evaluation apparatus, the evaluation apparatus checks the ratio of the outlet widths, or rather wall thicknesses, of the extruded material set at the extrusion device at the top and at the bottom of the extruder nozzle. As explained, sagging has the effect in particular of changing the wall thicknesses at the top and at the bottom of the tubular object, since the flowable components of the object sag downwards during sagging due to gravity. Since the wall thickness measurement according to the invention and the same-location comparison of the measured wall thickness values obtained between the first and second measurement positions can be used to reliably determine sagging that has actually occurred, this can be used as a basis for setting the extruder nozzle, in particular the outlet widths of the extruded material produced by it at the top and at the bottom, which leads to a desired final geometry of the tubular object. If the final cold values of the wall thickness are already measured at the second measurement position, the extruder nozzle can, for example, be controlled so that the wall thicknesses at the top and at the bottom of the tubular object are identical at this point. If further sagging is expected after the second measurement position, the extruder nozzle can be set accordingly so that at the second measurement position the wall thickness at the top of the tubular object is still correspondingly greater than the wall thickness at the bottom.

According to some embodiments of the invention, this enables hot-cold closed-loop control of the extrusion device on the basis of real measured values at the first and second measurement positions in a simple manner, in particular taking into account the sagging. By comparing the measured wall thickness values at the same location via the delay stage, distortions of the results due to changes in the tubular object along its longitudinal direction, for example as part of start-up of a production system comprising the extrusion device, are ruled out. The delay stage can be integrated into the evaluation apparatus, for example. It can be implemented by software or hardware, for example in the form of a runtime memory or a shift register.

To measure the wall thicknesses at the first and second measurement positions, the first and second wall thickness measuring apparatuses can in particular comprise transmitters that emit measurement radiation that at least partially radiates through the object. This can be electromagnetic radiation, for example, for which the object is at least partially transparent. The radiation is reflected at boundary surfaces of the object, in particular boundary surfaces of the walls of the object. From this, the respective wall thickness can be determined, for example, using runtime evaluations.

According to some embodiments, the first measurement position can be arranged downstream of a first cooling section and upstream of at least one further cooling section for the tubular object and the second measurement position can be arranged downstream of all cooling sections for the tubular object. The first measurement position can, in particular, be arranged downstream of only one cooling section and upstream of a plurality of further cooling sections. At the first measurement position, the tubular object already has a partially defined shape. At the same time, the object still has flowable components that are subject to sagging during further cooling. At the second measurement position, however, the object is essentially completely hardened in the aforementioned embodiment.

According to a further embodiment, it can be provided that the first wall thickness measuring apparatus at the first measurement position measures the wall thickness at at least one measurement location at the top and at at least one measurement location at the bottom of the tubular object, and that the second wall thickness measuring apparatus at the second measurement position measures the wall thickness at at least one measurement location at the top and at least one measurement location at the bottom of the tubular object. The wall thickness measurement at the top of the tubular object can be taken at the highest point of the object, for example. The measurement at the bottom can be taken accordingly at the lowest point of the object. Measuring and comparing the wall thicknesses at the top and bottom of the tubular object between the first and second measurement positions is particularly important for taking sagging into account, as explained above, since sagging is particularly noticeable in a change in wall thickness between the top and the bottom.

In some embodiments, the evaluation apparatus can also be configured to take a sagging factor into account when comparing the measured wall thickness values, which factor indicates an expected sagging of the tubular object between the first measurement position and the second measurement position. In particular, the evaluation apparatus can be designed to check and, if necessary, adapt the sagging factor by comparing the measured wall thickness values. Furthermore, the evaluation apparatus can be designed to compare the actual sagging of the tubular object between the first measurement position and the second measurement position with the sagging expected, in particular according to the sagging factor, between the first measurement position and the second measurement position on the basis of the comparison of the measured wall thickness values.

The sagging factor indicates the degree of sagging to be expected. The greater the sagging factor, the stronger the sagging is to be expected. The volume or mass flow rate of the still flowable viscous material of the object is approximately proportional to the sagging factor. The sagging factor thus represents, at each measurement position, an indicator, from which it is possible to deduce the extent to which the regularly deliberately set difference between the wall thicknesses exiting the extruder nozzle in the upper and lower regions will still change in the further course of the extrusion line. Based on the sagging factor, it is possible to achieve the desired, generally uniform wall thickness of the object over the entire circumference with the remaining sagging by setting the annular gap of the extruder nozzle and/or suitably setting the temperature of the extruder nozzle of the extrusion device. As will be explained in more detail below, it is also possible according to the invention for the first and/or second wall thickness measuring apparatus to measure the refractive index of the object at the first and/or second measurement position, respectively. The sagging factor can also be described as the product of a constant factor with the refractive index difference between the refractive index measured at the first measurement position and the cold value of the refractive index. The cold value of the refractive index can be present in particular at the second measurement position. The refractive index is known to be temperature-dependent, so that it changes regularly between the first measurement position and the second measurement position. The sagging factor can initially be ascertained empirically, for example. If the measurements according to the invention show that the ascertained sagging factor does not apply to the respective production process or the production system, it can be adapted accordingly. The evaluation apparatus can also be designed to compare a ratio of the wall thicknesses at the top and bottom of the tubular object at the first measurement position with a ratio of the wall thicknesses at the top and at the bottom of the tubular object at the second measurement position in order to compare the actual sagging with the expected sagging.

In some embodiments, the evaluation apparatus is designed to adapt the sagging factor when a deviation between the actual and the expected sagging is detected and/or to display a target ratio of the outlet widths of the extruded material at the top and at the bottom of the extruder nozzle resulting for a desired wall thickness geometry of the tubular object and/or to set this ratio by controlling the extrusion device.

The outlet widths or rather wall thicknesses of the extruded material at the top and at the bottom of the extruder nozzle can be adjusted as explained by mechanically setting the outlet gap at the top or at the bottom, respectively, of the extruder nozzle. Alternatively, or additionally, it is also possible to influence the outlet widths by controlling the temperature of the extruder nozzle, in particular a different temperature at the top and at the bottom of the extruder nozzle.

In a particularly practical manner, the first and/or the second wall thickness measuring apparatus can comprise a terahertz measurement apparatus or an X-ray measuring device. With terahertz measurement apparatuses, terahertz radiation is emitted on the tubular object in a wavelength range from 1 GHz to 6 THz, for example. Similarly to X-rays, this radiation can penetrate the object, in particular if it comprises a plastic material, as is common with tubular objects or cables. The aforementioned measuring apparatuses, which in particular do not use optical radiation such as laser radiation or the like, are particularly suitable for difficult production conditions in the context of extrusion lines, where vapor formation or contamination often occurs, which can interfere with optical measurement. In the case of X-ray measuring apparatuses, it should be noted that these must emit X-rays in a horizontal direction onto the object for upper and lower wall thickness measurements, for example.

According to a further embodiment, the first and/or second wall thickness measuring apparatus can be a portable handheld measuring apparatus. It is therefore a measuring apparatus that can be carried by an operator and can be used flexibly and as required at the first and/or second measurement position. In particular when using a portable wall thickness measuring apparatus, it is possible according to a further configuration that the first and second wall thickness measuring apparatus are formed by the same wall thickness measuring apparatus. In this case, the wall thickness could be measured, for example, first at the first measurement position and then at the second measurement position. The measured wall thickness values obtained in each case can then be compared with each other at the same location by delaying the measured wall thickness values obtained at the first measurement position via the delay stage in accordance with the conveying speed of the tubular object. With this embodiment, advantageously only one wall thickness measuring apparatus is required.

In order to reliably ensure a defined measuring alignment at the first and/or second measurement position, it is possible according to a further embodiment that a holder for the first and/or second wall thickness measuring apparatus is arranged at the first measurement position and/or at the second measurement position. The first and/or second wall thickness measuring apparatus can be detachably held in the holder. This is particularly advantageous in connection with portable wall thickness measuring apparatuses.

According to a further embodiment, it can be provided that the evaluation apparatus is further designed to determine the refractive index of the material of the tubular counterpart at the first measurement position and at the second measurement position from the measured wall thickness values obtained from the first wall thickness measuring apparatus and the measured wall thickness values obtained from the second wall thickness measuring apparatus.

As already explained, the refractive index is temperature-dependent and therefore changes regularly between the first and second measurement positions. In particular in the case of the wall thickness measuring apparatuses mentioned previously by way of example, first the optical wall thickness is measured, which can be converted into the geometric wall thickness using the refractive index. Knowledge of the refractive index of the material is of great importance for determining the geometric wall thicknesses. The refractive index is not only temperature-dependent, but also changes, for example, with a varying proportion of additives usually added to the plastic to be extruded, wherein the exact proportion of additives is often not precisely known and the proportion of additives can also fluctuate. The refractive index determined according to the invention can be taken into account accordingly when determining the wall thickness at the first and/or second measurement position. The sagging factor can also be checked on this basis, in particular due to the aforementioned relationship between the sagging factor and the refractive index difference between the first measurement position and the cold value of the refractive index, in particular at the second measurement position.

To determine the refractive index, the first and/or second wall thickness measuring apparatus can also have a reflector that reflects, for example, terahertz measurement radiation. A terahertz wall thickness measuring apparatus can comprise a terahertz transceiver, in which a terahertz transmitter and a terahertz receiver are integrated. For example, the refractive index can be determined from a comparison of the propagation time of measurement radiation emitted by a measurement apparatus without a tubular object arranged in the beam path of the measuring radiation with the transit time of the measuring radiation with a tubular object arranged in the beam path of the measuring radiation. This procedure for determining an unknown refractive index of an object is described, for example, in EP 3 265 748 B1. The refractive index determination can be carried out in a corresponding manner in the present case. However, it is also possible to determine the refractive index by using a measurement apparatus to determine the optical wall thickness of the tubular object, further by using the measurement apparatus to determine an outer diameter and an inner diameter of the tubular object, and by determining the refractive index of the tubular object from a comparison of the determined outer and inner diameters with the determined optical wall thickness. This alternative method of determining an unknown refractive index is described, for example, in DE 10 2018 128 248 A1. Again, this procedure can be applied in the present case.

According to a further embodiment, it can be provided that the evaluation apparatus is designed to take into account material parameters of the tubular object, in particular the thermal conductivity and/or the heat capacity, and/or production parameters, in particular the temperature of the extruder nozzle and/or the haul-off speed of the extrusion device and/or cooling parameters of the tubular object produced, when checking the setting of the extrusion device. In particular, changes to the aforementioned material and/or production parameters can be taken into account. The material or else production parameters explained have an influence in particular on the sagging and the sagging factor.

The device according to the invention can further comprise the extrusion device and/or the at least one cooling section and/or a conveying apparatus for conveying the tubular object along the conveying direction and/or the tubular object.

The device according to the invention can be suitable for carrying out the method according to the invention. Accordingly, the method can be carried out by a device according to the invention.

### BRIEF DESCRIPTION OF THE DRAWINGS

An exemplary embodiment of the invention is explained below in greater detail based on figures.

FIG. 1 schematically illustrates a side view of an embodiment of a device for checking the setting of an extrusion device, according to aspects of the disclosure.

FIG. 2 schematically illustrates a partial sectional representation of the device from FIG. 1.

### DETAILED DESCRIPTION OF THE INVENTION

If not otherwise specified, the same reference signs denote the same subject matter in the figures.

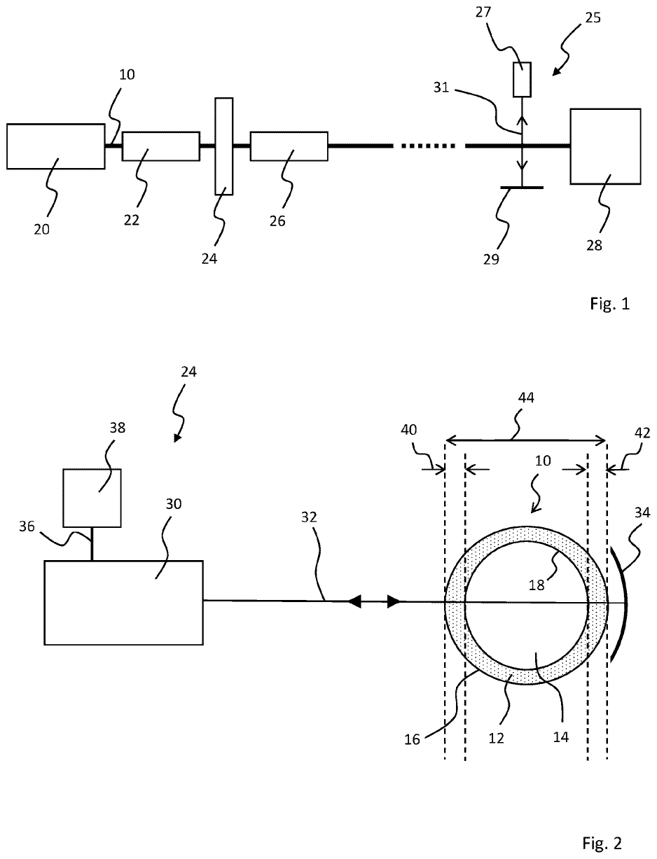

FIGS. 1 and 2 depict a tubular object 10, in the present case a tube 10, in particular a plastic tube 10, which has a wall 12, a hollow space 14 delimited by the tube 10, an outer surface 16 which is circular in cross-section and an inner surface 18 which is likewise circular in cross-section and delimits the hollow space 14. The tube 10 is, in the present example, extruded with the aid of an extruder in an extrusion device 20 and conveyed, from left to right in FIG. 1, along its longitudinal axis by means of a suitable conveying apparatus. After exiting the, for example annular, extruder nozzle of the extrusion device 20, the tube 10 initially passes through a first cooling section 22, in which the tube 10, which exits the extruder nozzle heated to a great extent and not yet completely solidified, that is to say still having recrystallizing and flowable components (melt), is cooled down. The first cooling section 22 can comprise a calibration apparatus, in particular a calibration sleeve, against which the tube 10 is pressed, for example by a vacuum and the normal pressure inside the tube 10. This determines the final outer diameter of the tube 10 preformed by the extruder nozzle. As the process continues, the tube 10 passes through a first wall thickness measuring apparatus 24, in the present case a terahertz measurement apparatus 24, in which the refractive index and the wall thickness are determined in a manner explained in more detail below. Following the first terahertz measurement apparatus 24, the tube 10 passes through at least one further cooling section 26, in which further cooling occurs. The dashed lines of the tube 10 illustrate that further cooling sections 26 can be provided. After the tube 10 has completely solidified, it is cut to predefined lengths, for example in a cutting-to-length apparatus 28 having a flying saw.

The structure and the function of the first terahertz measuring apparatus 24 are to be explained in greater detail with reference to FIG. 2. In the depicted example, the first terahertz measurement apparatus 24 comprises a transceiver 30, in which a transmitter and a detector for terahertz radiation are combined. The transmitter emits terahertz radiation 32 onto the tube 10. The terahertz radiation is reflected at different boundary surfaces of the tube 10 and at a reflector 34 arranged opposite the transceiver 30 and travels back to the transceiver 30 where it is detected by the detector. The transceiver 30 is, furthermore, connected to an evaluation apparatus 38 via a line 36. The reflected radiation received by the detector generates corresponding measurement signals, which are forwarded to the evaluation apparatus 38 via the line 36. In this way, the evaluation apparatus 38 can determine, for example, the wall thicknesses 40, 42 drawn in in FIG. 2, for example using propagation time measurements. The evaluation apparatus 38 can also determine the refractive index of the tube material on the basis of the measurement signals received by the detector, as is described, by way of example, in WO 2016/139155 A1 or DE 10 2018 128 248 A1.

For example, the wall thicknesses 40, 42 of the tube 10 as well as the refractive index are determined with the first terahertz measuring apparatus 24 at the measurement position shown in FIG. 1, at which the tube 10 has not yet completely solidified, that is to say still has flowable components. The transceiver 30 can rotate, by way of example, along a circular path about the tube 10 and, thus, determine the wall thickness and the refractive index at different locations over the circumference of the tube 10. The reflector 34 can likewise rotate about the tube 10. However, it is also possible for the reflector 34 to be dispensed with.

A second wall thickness measuring apparatus 25, in the present case also a terahertz measurement apparatus 25, is located between the at least one further cooling section 26, in particular the last cooling section 26, and the cutting-to-length device 28. The second terahertz measurement apparatus 25 also comprises a transceiver 27, in which a transmitter and a detector for terahertz radiation are combined. Another reflector 29 for terahertz radiation is arranged on an opposite side of the tube 10. This reflector reflects terahertz radiation 31 emitted by the transmitter back to the detector after it radiates through the tube 10 and reflects at the boundary surfaces of the tube 10.

At the second measurement position, at which the tube 10 is essentially completely hardened, the second terahertz measurement apparatus 25 measures the refractive index and at least the wall thickness of the tube 10 at least at the top and bottom of the tube 10. The second terahertz measurement apparatus can operate in the manner explained above for the first terahertz measurement apparatus. For example, the second terahertz measurement apparatus 25 can be a portable handheld measurement apparatus. In this case, a holder for the second terahertz measurement apparatus 25 can be provided at the second measurement position, into which holder it can be detachably inserted. The wall thickness or else refractive index can be measured in the manner explained above. The measurement results from the second terahertz measurement apparatus 25 are also available at the evaluation apparatus 38.

The evaluation apparatus 38 further comprises a delay stage, the delay time of which corresponds to the conveying time of the tube 10 between the first measurement position and the second measurement position. The measured values from the first terahertz measurement apparatus 24 are delayed by the delay stage compared to the measured values from the second terahertz measurement apparatus 25 by the delay stage. The evaluation apparatus 38 compares the measured values from the first terahertz measurement apparatus 24, which are delayed by the delay stage, with the measured values from the second terahertz measurement apparatus 25, so that measured values obtained at the same location of the object 10 are compared with one another. By comparing the measured values, in particular the measured wall thickness values obtained at the top and bottom of the tube 10 at the first and second measurement positions, a sagging factor, which indicates an expected sagging between the first measurement position and the second measurement position, is checked, for example empirically ascertained. For this purpose, the evaluation apparatus 38 can compare a ratio of the wall thicknesses at the top and at the bottom of the tube 10 at the first measurement position with a ratio of the wall thicknesses at the top and at the bottom of the tube 10 at the second measurement position. If a deviation from the expected sagging indicated by the sagging factor is detected, this can be indicated, for example to an operator, by the evaluation apparatus 38 and/or the sagging factor can be corrected accordingly. The evaluation apparatus 38 can also control the extrusion device 20 in order to adapt the outlet widths or rather wall thicknesses of the extruded material at the top and at the bottom of the extruder nozzle in such a way that a desired ratio of the wall thicknesses at the top and at the bottom of the tube 10 is achieved at the second measurement position. To set the outlet widths, for example, an annular gap of the extruder nozzle can be mechanically adjusted and/or the temperature of the extruder nozzle of the extrusion device 20 can be adapted. The sagging factor can also be checked using the refractive index also determined at the first measurement position and at the second measurement position. In addition, the geometric wall thickness at the first and second measurement positions can be determined on the basis of the refractive index determination.

### LIST OF REFERENCE SIGNS

10 Tubular object
12 Wall
14 Hollow space
16 Outer surface
18 Inner surface
20 Extrusion device
22 Cooling section
24 First terahertz measurement apparatus (first wall thickness measuring apparatus)
25 Second terahertz measurement apparatus (second wall thickness measuring apparatus)
26 Cooling section
27 Transceiver
28 Cutting-to-length apparatus
29 Reflector
30 Transceiver
31 Terahertz radiation
32 Terahertz radiation
34 Reflector
36 Line
38 Evaluation apparatus
40, 42 Wall thicknesses

1.-16. (canceled)

17. A device for checking the setting of an extrusion device producing a tubular object conveyed in a conveying direction and configured so that extruded material with different outlet widths exits at a top and at a bottom of an extruder nozzle of the device, the device comprising:
a first wall thickness measuring apparatus configured to measure a wall thickness of at least one wall of the tubular object at a first measurement position that is arranged in the conveying direction upstream of at least one cooling section for the tubular object;
a second wall thickness measuring apparatus configured to measure the wall thickness of the at least one wall of the tubular object at a second measurement position that is arranged in the conveying direction downstream of the first measurement position; and
an evaluation apparatus configured to receive wall thickness values from the first wall thickness measuring apparatus and measured wall thickness values from the second wall thickness measuring apparatus,
wherein the measured wall thickness values from the first wall thickness measuring apparatus are time delayed compared to the measured wall thickness values from the second wall thickness measuring apparatus by a delay stage, wherein the time delay corresponds to a conveying time of the tubular object between the first and second measurement positions,
wherein the evaluation apparatus is configured to check a ratio of the outlet widths of the extruded material set at the extrusion device at the top and at the bottom of the extruder nozzle based on a comparison of the measured wall thickness values from the first wall thickness measuring apparatus with the measured wall thickness values from the second wall thickness measuring apparatus.

18. The device according to claim 17, wherein the first measurement position is positioned downstream of a first cooling section and upstream of at least a second cooling section, wherein the second measurement position is arranged downstream of all cooling sections.

19. The device according to claim 17, wherein the first wall thickness measuring apparatus at the first measurement position measures the wall thickness at a top of the tubular object at at least one measurement location and at a bottom of the tubular object at at least one measurement location, and wherein the second wall thickness measuring apparatus at the second measurement position measures the wall thickness at the top of the tubular object at at least one measurement location and at the bottom of the tubular object at at least one measurement location.

20. The device according to claim 19, wherein when comparing the measured wall thickness values, the evaluation apparatus is configured to take a sagging factor into account, wherein the sagging factor indicates an expected sagging of the tubular object between the first measurement position and the second measurement position.

21. The device according to claim 20, wherein the evaluation apparatus is configured to: (i) check the sagging factor based on the comparison of the measured wall thickness values; (ii) adapt a setting of the extrusion device based on the sagging factor.

22. The device according to claim 21, wherein the evaluation apparatus is configured to compare an actual sagging of the tubular object between the first measurement position and the second measurement position with an expected sagging between the first measurement position and the second measurement position on based on the comparison of the measured wall thickness values.

23. The device according to claim 22, wherein the evaluation apparatus is configured to compare a ratio of the wall thicknesses at the top and at the bottom of the tubular object at the first measurement position with a ratio of the wall thicknesses at the top and at the bottom of the tubular object at the second measurement position in order to compare the actual sagging with the expected sagging.

24. The device according to claim 23, wherein the evaluation apparatus is configured to at least one of:
(i) adapt the sagging factor when a deviation between the actual and the expected sagging is detected;
(ii) display a target ratio of outlet widths of the extruded material at the top and at the bottom of the extruder nozzle resulting for a desired wall thickness geometry of the tubular object; or
(iii) set the target ratio by controlling the extrusion device.

25. The device according to claim 17, wherein at least one of the first wall thickness measuring apparatus and the second wall thickness measuring apparatus comprises one of: (i) a terahertz measurement apparatus; or (ii) an X-ray measurement apparatus.

26. The device according to claim 17, wherein at least one of the first wall thickness measuring apparatus or the second wall thickness measuring apparatus comprises a portable handheld measuring apparatus.

27. The device according to claim 26, wherein the first and the second wall thickness measuring apparatuses are comprised of a same wall thickness measuring apparatus.

28. The device according to claim 26, further comprising a holder for at least one of the first wall thickness measuring apparatus or the second wall thickness measuring apparatus, wherein the holder is arranged at at least one of the first measurement position or at the second measurement position.

29. The device according to claim 17, wherein the evaluation apparatus is further configured to determine a refractive index of a material comprising the tubular object at the first and second measurement position from the measured wall thickness values obtained from the first wall thickness measuring apparatus and from the measured wall thickness values obtained from the second wall thickness measuring apparatus.

30. The device according to claim 17, wherein the evaluation apparatus is configured to at least one of:
consider material parameters of the tubular object;
consider production parameters of the tubular object; or
consider cooling parameters of the tubular object produced when checking a setting of the extrusion device.

31. The device according to claim 30, wherein the material parameters comprise at least one of: (i) a thermal conductivity; or (ii) a heat capacity.

32. The device according to claim 30, wherein the production parameters include at least one of: (i) a temperature of the extruder nozzle; or (ii) a haul-off speed of the extrusion device.

33. The device according to claim 17, further comprising at least one of:
an extrusion device;
at least one cooling section;
a conveying apparatus configured to convey the tubular object along the conveying direction; or
the tubular object.

34. A method for checking the setting of an extrusion device producing a tubular object conveyed in a conveying direction, wherein the extrusion device is set such extruded material with different outlet widths exits at a top and at a bottom of an extruder nozzle of the extrusion device, comprising:
providing a device for checking the setting of an extrusion device, the device comprising,
a first wall thickness measuring apparatus configured to measure the wall thickness of at least one wall of the tubular object at a first measurement position that is arranged in the conveying direction upstream of at least one cooling section for the tubular object,
a second wall thickness measuring apparatus configured to measure the wall thickness of the at least one wall of the tubular object at a second measurement position that is arranged in the conveying direction downstream of the first measurement position, and
an evaluation apparatus configured to receive wall thickness values from the first wall thickness measuring apparatus and measured wall thickness values from the second wall thickness measuring apparatus, wherein the measured wall thickness values from the first wall thickness measuring apparatus are delayed compared to the measured wall thickness values from the second wall thickness measuring apparatus by a delay stage of the device, wherein the delay time corresponds to the conveying time of the tubular object between the first and second measurement positions; and
checking, using the device, a ratio of the outlet widths of the extruded material set at the extrusion device at the top and at the bottom of the extruder nozzle based on a comparison of the measured wall thickness values from the first wall thickness measuring apparatus with the measured wall thickness values from the second wall thickness measuring apparatus.
